(19) United States
(12) Patent Application Publication
(10) Pub. No.: US 2026/0222697 A1
(43) Pub. Date: Jul. 30, 2026

(54) EVENT VISION SENSORS WITH DIGITAL EVENT DETECTION

(71) Applicant: OMNIVISION TECHNOLOGIES, INC., Santa Clara, CA (US)

(72) Inventors: Andreas Suess, San Jose, CA (US); Boyd Fowler, Sunnyvale, CA (US)

(21) Appl. No.: 19/037,247

(22) Filed: Jan. 26, 2025

(51) Int. Cl. H04N 25/47; H04N 25/616; H04N 25/77; H04N 25/78

(52) U.S. Cl. CPC H04N 25/47; H04N 25/616; H04N 25/77; H04N 25/78

(57) ABSTRACT

Event vision sensors with digital event detection are disclosed herein. In one embodiment, an image sensor includes an EVS pixel with a photosensor, an integrating-type photo-detecting stage, and in-pixel sampling circuitry including multiple sampling nodes. An analog-to-digital converter (ADC) is coupled to the in-pixel sampling circuitry and converts analog irradiance levels into digital signals. Event detection circuitry coupled to the ADC computes event signals based on temporal contrast differences between corresponding digital signals output by the ADC and a contrast threshold. The in-pixel sampling circuitry samples integrated reference and momentary integrated signal irradiance levels during different operational phases. The event detection circuitry performs correlated double sampling operations to compute digital difference signals and asserts an event signal when the temporal contrast difference exceeds the contrast threshold.

### TECHNICAL FIELD

This disclosure relates generally to image sensors. For example, several embodiments of the present technology are directed to event vision sensors and/or hybrid image sensors that employ EVS pixels and corresponding pixel-level or cluster-level analog-to-digital converters to facilitate digital event detection.

### BACKGROUND

Image sensors have become ubiquitous and are now widely used in digital cameras, cellular phones, security cameras, as well as medical, automobile, and other applications. As image sensors are integrated into a broader range of electronic devices, it is desirable to enhance their functionality, performance metrics, and the like in as many ways as possible (e.g., resolution, power consumption, dynamic range, etc.) through both device architecture design as well as image acquisition processing.

A typical image sensor operates in response to image light from an external scene being incident upon the image sensor. The image sensor includes an array of pixels having photosensitive elements (e.g., photodiodes) that absorb a portion of the incident image light and generate image charge upon absorption of the image light. The image charge photogenerated by the pixels may be measured as analog output image signals on column bitlines that vary as a function of the incident image light. In other words, the amount of image charge generated is proportional to the intensity of the image light, which can be read out as analog image signals from the column bitlines and converted to digital values to provide information that is representative of the external scene.

### BRIEF DESCRIPTION OF THE DRAWINGS

Non-limiting and non-exhaustive embodiments of the present technology are described below with reference to the following figures, in which like or similar reference numbers are used to refer to like or similar components throughout unless otherwise specified.

FIG. 1 is a partially schematic diagram of a stacked hybrid complementary metal oxide semiconductor (CMOS) image sensor (CIS) and event-based vision sensor (EVS) system, configured in accordance with various embodiments of the present technology.

FIG. 2 is a partially schematic circuit diagram of an EVS pixel configured in accordance with various embodiments of the present technology.

FIG. 3 is a partially schematic circuit diagram of an analog-to-digital converter and event detection circuitry, each configured in accordance with various embodiments of the present technology.

Skilled artisans will appreciate that elements in the figures are illustrated for simplicity and clarity and are not necessarily drawn to scale. For example, the dimensions of some of the elements in the figures may be exaggerated relative to other elements to aid in understanding of various aspects of the present technology. In addition, common but well-understood elements or methods that are useful or necessary in a commercially feasible embodiment are often not depicted in the figures, or described in detail below, to avoid unnecessarily obscuring the description of various aspects of the present technology.

### DETAILED DESCRIPTION

The present technology is generally directed to event vision sensors and hybrid image sensors. For example, several embodiments of the present technology discussed in detail below relate to event vision sensor (EVS) pixels that employ integrating-type photo-detecting stages and in-pixel sampling circuitry in combination with analog-to-digital converts to perform digital event detection. As a specific example, several EVS pixels described in detail below include in-pixel sampling circuitry that facilitates (a) sampling an integrated reference irradiance level during a first phase of operation and a momentary integrated signal irradiance level during a second phase of operation and (b) performing correlated doubling sampling (CDS) operations to reduce, minimize, and/or eliminate noise (e.g., fixed pattern noise, kTC noise, etc.). Continuing with this specific example, the in-pixel sampling circuitry can include two nodes: a first node with a first switch and a first capacitor to selectively sample integrated irradiance levels, and a second node with a second switch and a second capacitor for sampling noise levels (also referred to herein as reset levels). These analog samples can be read out from the in-pixel sampling circuitry and converted into digital signals by a pixel-level, cluster-level, or peripheral level analog-to-digital converter (ADC). In turn, event detection circuitry can (i) perform CDS operations to factor out noise and isolate a digital representation of a momentary integrated signal irradiance level and a digital representation of a corresponding integrated reference irradiance level, (ii) compute a difference between the digital representations, and (iii) compare the difference to a contrast threshold to generate event signals, performing all computations in the digital domain.

In the following description, specific details are set forth to provide a thorough understanding of aspects of the present technology. One skilled in the relevant art will recognize, however, that the systems, devices, and techniques described herein can be practiced without one or more of the specific details set forth herein, or with other methods, components, materials, etc.

Reference throughout this specification to an “example” or an “embodiment” means that a particular feature, structure, or characteristic described in connection with the example or embodiment is included in at least one example or embodiment of the present technology. Thus, use of the phrases “for example,” “as an example,” or “an embodiment” herein are not necessarily all referring to the same example or embodiment and are not necessarily limited to the specific example or embodiment discussed. Furthermore, features, structures, or characteristics of the present technology described herein may be combined in any suitable manner to provide further examples or embodiments of the present technology.

Spatially relative terms (e.g., “beneath,” “below,” “over,” “under,” “above,” “upper,” “top,” “bottom,” “left,” “right,” “center,” “middle,” and the like) may be used herein for ease of description to describe one element's or feature's relationship relative to one or more other elements or features as illustrated in the figures. It will be understood that the spatially relative terms are intended to encompass different orientations of a device or system in use or operation, in addition to the orientation depicted in the figures. For example, if a device or system illustrated in the figures is rotated, turned, or flipped about a horizontal axis, elements or features described as “below” or “beneath” or “under” one or more other elements or features may then be oriented “above” the one or more other elements or features. Thus, the exemplary terms “below” and “under” are non-limiting and can encompass both an orientation of above and below. The device or system may additionally, or alternatively, be otherwise oriented (e.g., rotated ninety degrees about a vertical axis, or at other orientations) than illustrated in the figures, and the spatially relative descriptors used herein are interpreted accordingly. In addition, it will also be understood that when an element is referred to as being “between” two other elements, it can be the only element between the two other elements, or one or more intervening elements may also be present.

Temporal relative terms such as “simultaneously,” “substantially simultaneously,” or “at the same time” are used herein to describe simultaneous performance or operation occurrence in a near instantaneous manner that takes into account necessary delays in signal transmission and/or processing, such as circuitry processing time, signal propagation time, computing time, or the like associated with circuit components. Thus, unless otherwise specified, “simultaneously,” “substantially simultaneously,” or “at the same time” as used herein may refer to events or operations that occur at the exact same time or within one second or less of each other after taking into account signal transmission and/or processing.

It will be understood that, although the terms first, second, third, etc., may be used in the disclosure and claims to describe various elements, these elements should not be limited by these terms and should not be used to determine the process sequence or formation order of associated elements. Unless otherwise indicated, these terms are merely used to distinguish one element from another element. Thus, a first element discussed below could be termed a second element without departing from the teachings of the disclosed embodiments. As another example, an element can be termed a “third element” to distinguish the element (e.g., for antecedent-basis purposes) from another element termed a “first element,” and without requiring the presence of a second element.

It is appreciated that the term “semiconductor material” recited throughout the disclosure may correspond to a part of or an entirety of a semiconductor wafer (e.g., a silicon wafer). In some embodiments, the semiconductor material may include or otherwise formed of silicon, a silicon germanium alloy, germanium, a silicon carbide alloy, an indium gallium arsenide alloy, any other alloys formed of III-V group compounds, combinations thereof, one or more epitaxial layers of the aforementioned materials, or a bulk substrate thereof. More specifically, semiconductor material may correspond to any semiconductor material or combination of materials that may be doped or otherwise configured to facilitate the formation of an integrated circuit (e.g., forming individual circuitry components such as source/drain regions of transistors, memory elements, photodiodes, or the like). It is appreciated that the term “photodiode” may correspond to a doped region disposed within the semiconductor material configured to photogenerate image charge(s) (e.g., one or more electrons or holes) in response to incident light. For example, photodiode may correspond to an n-doped region disposed within a p-type semiconductor material or an n-doped region surrounded by a p-type well disposed within the semiconductor material.

Throughout this specification, several terms of art are used. These terms are to take on their ordinary meaning in the art from which they come, unless specifically defined herein or the context of their use would clearly suggest otherwise. It should be noted that element names and symbols may be used interchangeably through this document (e.g., Si vs. silicon); however, both have identical meaning.

### A. Overview

An active pixel sensor employs an array of pixels that are used to capture intensity images/video of an external scene. More specifically, the pixels are used to obtain CIS information (e.g., intensity information) corresponding to light from the external scene that is incident on the pixels. CIS information obtained during an integration period is read out at the end of the integration period and used to generate a corresponding intensity image of the external scene.

In comparison, event vision sensors (e.g., event driven sensors or dynamic vision sensors) employ EVS pixels that are usable to obtain non-CIS information (e.g., contrast information, intensity changes, event data) corresponding to light from an external scene that is incident on those EVS pixels. Many event vision sensors read out an EVS pixel and/or convert a corresponding pixel signal into a digital signal only when the EVS pixel detects a change (e.g., an event) in the external scene. In other words, in most event vision sensors, EVS pixels that do not detect a change in the external scene are not read out and/or pixel signals corresponding to such EVS pixels are not converted into digital signals (thereby saving power). As a result, unlike active pixel sensors with synchronous integration times, these event vision sensors do not suffer from limited dynamic ranges and are able to accurately capture high-speed motion. Thus, these event visions sensors are often more robust than active pixel sensors in low lighting conditions and/or in highly dynamic scenes because they are not affected by under/over exposure or motion blur associated with a synchronous shutter. Stated another way, such event vision sensors can be used to provide ultra-high frame rates and to accurately capture high-speed motions.

Hybrid image sensors employ an array of pixels that includes a combination of (i) active (CIS) pixels usable to obtain CIS information corresponding to light from an external scene and (ii) EVS pixels usable to obtain non-CIS information corresponding to light from the external scene. Such hybrid image sensors are therefore able to simultaneously capture (a) intensity images/video of an external scene and (b) events occurring within the external scene.

An EVS pixel is commonly configured such that its output is used to yield specific values when log intensity of light incident on a photosensor of the pixel exceeds predefined thresholds. More specifically, an EVS pixel is often configured such that its output yields a +1 value when log intensity increases by an amount greater than a first predefined threshold, indicating that an UP event (e.g., light changing from darker to brighter and greater than the first predefined threshold) has been detected within an external scene. In addition, the EVS pixel is often configured such that its output yields a −1 value when log intensity decreases by an amount greater than a second predefined threshold, indicating that a DOWN event (e.g., light changing from brighter to darker and greater than the second predefined threshold) has been detected within the external scene. The output of the EVS pixel can be used to yield no value (e.g., a value equivalent to zero (0)) when changes in log intensity observed by the EVS pixel do not exceed the first or second predefined thresholds, indicating that neither an UP event nor a DOWN event have been detected in the external scene.

Such EVS pixels typically include per-pixel circuitry that receives photocurrent as input and communicates events with row/column peripheral readout circuitry. In particular, such EVS pixels typically employ an analog front-end circuit for detection of events from photocurrent changes. Use of an analog front-end circuit, however, is associated with several drawbacks. For example, analog front-end circuits continuously consume DC power. As another example, some dynamic behavior of the analog front-end circuits can be signal dependent, making the dynamic behavior susceptible to problems associated with slewing from source follower transistors, kick-back from reset operations, etc. As still another example, scalability of analog front-end circuits is limited by fixed pattern noise (FPN) requirements, including considerations for amplifier sizing and capacitance ratios.

To address these concerns, the present technology is generally directed to event vision sensors and hybrid imaging sensors with digital event detection. For example, several embodiments disclosed herein are directed to event vision sensors and/or hybrid image sensors that employ EVS pixels having integrating-type front-end circuits. The integrating-type front-end circuits are each configured to synchronously produce analog signals indicative of non-CIS information (e.g., contrast information, intensity changes, event data), also referred to herein as EVS information, corresponding to light from an external scene that is incident on a photosensor of the respective EVS pixel. Each integrating-type front-end circuit includes or is coupled to an analog-to-digital converter (ADC) that is configured to convert analog signals produced using the integrating-type front-end circuit into corresponding digital signals.

As a specific example, an EVS pixel of the present technology can include an integrating-type photo-detecting stage coupled to in-pixel sampling circuitry. During a first phase of operation, a first reset level (also referred to herein as a “first noise level,” a “first noise signal,” a “first noise level signal,” and the like) can be sampled using a node of the in-pixel sampling circuitry, and an integrated reference irradiance level (inclusive of noise) can be sampled using another node of the in-pixel sampling circuitry. These analog samples can be (e.g., individually) read out of the in-pixel sampling circuitry to an analog-to-digital converter (ADC), converted into corresponding digital signals, and compared as part of a first correlated double sampling operation to produce a first digital difference signal. In some embodiments, the first digital difference signal can be stored to a pixel-level or cluster-level buffer (also referred to herein as a “frame buffer”).

During a second phase of operation, a second reset level (also referred to herein as a “second noise level,” a “second noise signal,” a “second noise level signal,” and the like) can be sampled using a node of the in-pixel sampling circuitry, and a momentary integrated signal irradiance level (inclusive of noise) can be sampled using another node of the in-pixel sampling circuitry. These analog samples can be (e.g., individually) readout out to the ADC, converted into corresponding digital signals, and compared as part of a second correlated double sampling operation to produce a second digital difference signal.

The second digital difference signal can be compared to the first digital difference signal (e.g., stored to the buffer) to produce a third digital difference signal. In turn, the third digital difference signal can be compared to a contrast threshold. When the third digital difference signal is greater than (or equal to) the contrast threshold, an event signal can be asserted, indicating that the EVS pixel has detected an event in an external scene monitored by the EVS pixel. When an event is detected, the EVS pixel can be transitioned back to the first phase of operation to sample a new integrated reference irradiance level before returning to the second phase. On the other hand, when the third digital difference signal is less than (or equal to) the contrast threshold, the event signal can be de-asserted (or remain de-asserted), indicating that the EVS pixel has not detected an event in the external scene. As a result, the EVS pixel can remain in the second phase and be used to sample and convert a new momentary integrated signal irradiance level into another digital signal for comparison to the digital integrated reference irradiance level currently stored in the buffer. Thus, event vision sensors, hybrid imaging sensors, and/or EVS pixels configured in accordance with various embodiments of the present technology are configured to fully or entirely perform CDS operations, difference computations, and event detection in the digital domain.

In some embodiments, the ADC used to convert analog samples into corresponding digital signals can be pixel-level ADC (e.g., as opposed to a column-level ADC). For example, the ADC can be positioned within (e.g., on a same die as) the EVS pixel, and/or the ADC can be dedicated to (e.g., correspond only to) a single/independent/unique EVS pixel. In other embodiments, the ADC can be a cluster-level ADC (e.g., as opposed to a column-level ADC). For example, the ADC can be shared by a group of two or more EVS pixels (e.g., of different rows and/or different columns).

Use of a pixel-level or cluster-level ADC to provide digital samples and use of an event detection circuit to compute differences and handle threshold comparisons entirely in the digital domain are expected to offer several advantages. For example, when latency requirements are low, part of a front-end circuit (e.g., the ADC) for one or more EVS pixels of the present technology can be powered down to reduce power consumption and/or conserve power. As another example, assuming that a small form factor ADC technology (e.g., ramp converters) is used, use of integrating-type front-end circuits with pixel-level or cluster-level ADCs is expected to improve scalability and help overcome latency bottlenecks. Furthermore, because EVS pixels configured in accordance with various embodiments of the present technology employ integrating-type front-end circuits with pixel-level or cluster-level ADCs, latency is expected to be determined by the exposure time and is no longer expected to be signal dependent. Moreover, use of correlated doubling sampling (CDS) techniques is expected to reduce, minimize, and/or eliminate fixed pattern noise and/or kTC noise from samples of integrated irradiance levels.

### B. Selected Embodiments of Event Vision Sensors with Digital Event Detection, and Associated Systems, Devices, and Methods

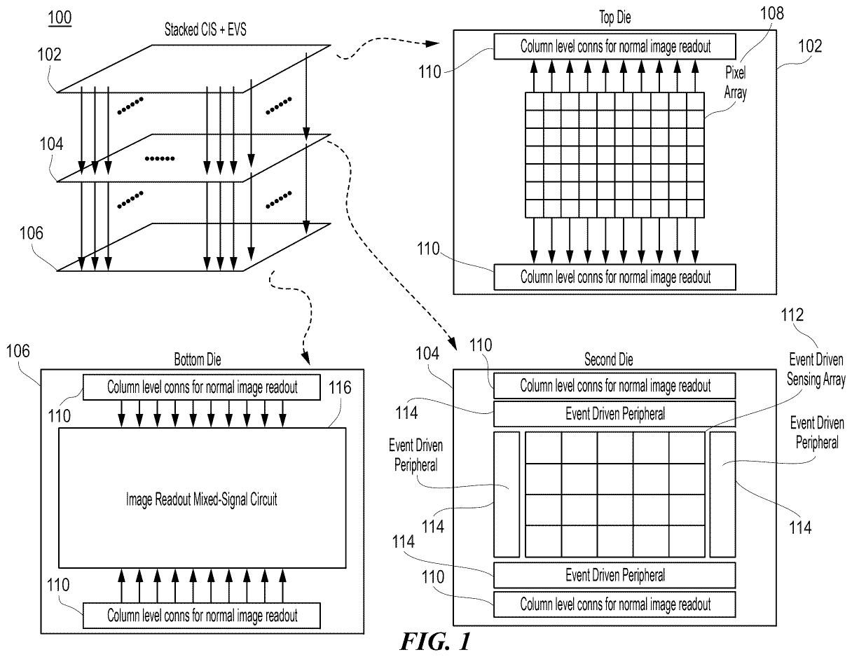

FIG. 1 is a partially schematic diagram of a stacked complementary metal oxide semiconductor (CMOS) image sensor (CIS) with an event-based vision sensor (EVS) system 100 (“the stacked system 100”), configured in accordance with various embodiments of the present technology. As shown, the stacked system 100 includes a first die 102, a second die 104, and a third die 106 that are stacked and coupled together in a stacked chip scheme. In some embodiments, the first die 102, the second die 104, and the third die 106 are semiconductor dies that include a suitable semiconductor material (e.g., silicon). In the illustrated embodiment, the first die 102 (also referred to herein as the “top die”) includes a pixel array 108. The third die 106 (also referred to herein as the “bottom die”) includes an image readout circuit 116 (also referred to herein as “image readout mixed-signal circuitry”). The image readout circuit 116 can be coupled to the pixel array 108 of the top die 102 through column level connections for normal image readout 110 (e.g., for intensity or luminance signal readout). In some embodiments, the column level connections for normal image readout 110 are implemented from column bitlines of the pixel array 108 with through silicon vias (TSVs) that extend between the top die 102 and the bottom die 106, and that are routed through the second die 104.

In some embodiments, the pixel array 108 is a two-dimensional (2D) array including a plurality of pixel cells (also referred to as “pixels” or as “pixel circuits”) that each includes at least one photosensor (e.g., at least one photodiode) exposed to incident light. As shown in the illustrated embodiment, the pixels are arranged into rows and columns. Pixels of the pixel array 108 can be operated at least partially as CIS pixels and/or at least partially as EVS pixels. When operated at least partially as CIS pixels, photosensors of the pixels can be used to acquire image data of an external scene (e.g., a person, place, object, etc., within the external scene) which can then be used to render images and/or video of the external scene. For example, each pixel, when at least partially operated in a CIS mode, can include one or more photosensors configured to photogenerate image charge in response to the incident light. After each pixel that is at least partially operated in a CIS mode has acquired its image charge, the corresponding analog image charge data can be read out by the image readout circuit 116 in the bottom die 106 through the column bit lines. In some embodiments, the image charge from each row of the pixel array 108 may be read out in parallel through column bit lines by the image readout circuit 116.

The image readout circuit 116 in the bottom die 106 can include amplifiers, analog to digital converter (ADC) circuitry, associated analog support circuitry, associated digital support circuitry, etc., for normal image readout and processing. In some embodiments, the image readout circuit 116 may also include event driven readout circuitry, which is described in greater detail below. In operation, the photogenerated analog image charge signals are read out from the pixel cells of pixel array 108, amplified, and converted to digital values in the image readout circuit 116. In some embodiments, image readout circuit 116 may read out a row of image data at a time. In other examples, the image readout circuit 116 may read out the image data using a variety of other techniques (not illustrated), such as a serial readout or a full parallel readout of all pixels simultaneously. The image data may be stored or even manipulated by applying post image effects (e.g., crop, rotate, remove red eye, adjust brightness, adjust contrast, and the like).

In the illustrated embodiment, the second die 104 (also referred to herein as the “middle die”) includes an event driven sensing array 112 that is coupled to the pixel array 108 in the top die 102. In some embodiments, the event driven sensing array 112 is coupled to the pixels of the pixel array 108 through hybrid bonds between the top die 102 and the middle die 104. The event driven sensing array 112 can include an array of event driven circuits. In some embodiments, each one of the event driven circuits in the event driven sensing array 112 is coupled to at least one of the plurality of pixels of the pixel array 108 through hybrid bonds between the top die 102 and the middle die 104 to synchronously detect events that occur in light that is incident upon the pixel array 108 in accordance with the teachings of the present disclosure.

In some embodiments, corresponding event detection signals are generated by the event driven circuits (e.g., integrating-type photo-detecting stages, in-pixel sampling circuitry, analog-to-digital converters, and/or event detection circuits) in the event driven sensing array 112. The event detection signals can be received and processed by event driven peripheral circuitry 114 (e.g., event detection circuitry) that, in some embodiments, is arranged around the periphery of the event driven sensing array 112 in the middle die 104 (as is shown in FIG. 1) or is positioned in the bottom die 106. The embodiment illustrated in FIG. 1 also illustrates column level connections for normal image readout 110 that are routed through the middle die 104 between the top die 102 and the bottom die 106.

Although discussed above in the context of hybrid image sensors, EVS pixels of the present technology can alternatively be employed in event vision sensors that omit CIS pixels. In these embodiments, circuitry of the EVS pixels can be distributed across one or more dies. For example, photosensors, all or a subset of integrating-type photo-detecting stages, all or a subset of in-pixel sampling circuitry, all or a subset of ADCs, all or a subset of event detection circuitry, and/or all or a subset of reset circuitry can be co-located on a same die. Alternatively, photosensors can be positioned on a first (top) die; all or a subset of integrating-type photo-detecting stages of the EVS pixels can be positioned on the first die and/or on a second (bottom or middle) die; all or a subset of in-pixel sampling circuitry can be position on the first die and/or on a second (bottom or middle die); all or a subset of analog digital converters can be positioned on the first die, the second die, and/or a third (bottom) die; all or a subset of event detection circuitry can be positioned on the second die and/or the third die; and/or all or a subset of reset circuitry can be positioned on the first die, the second die, and/or the third die. When distributed across multiple dies, the various circuitry can be connected using interconnect structures, such as TSVs, vias, hybrid bonds (e.g., pixel-level hybrid bonds), etc.

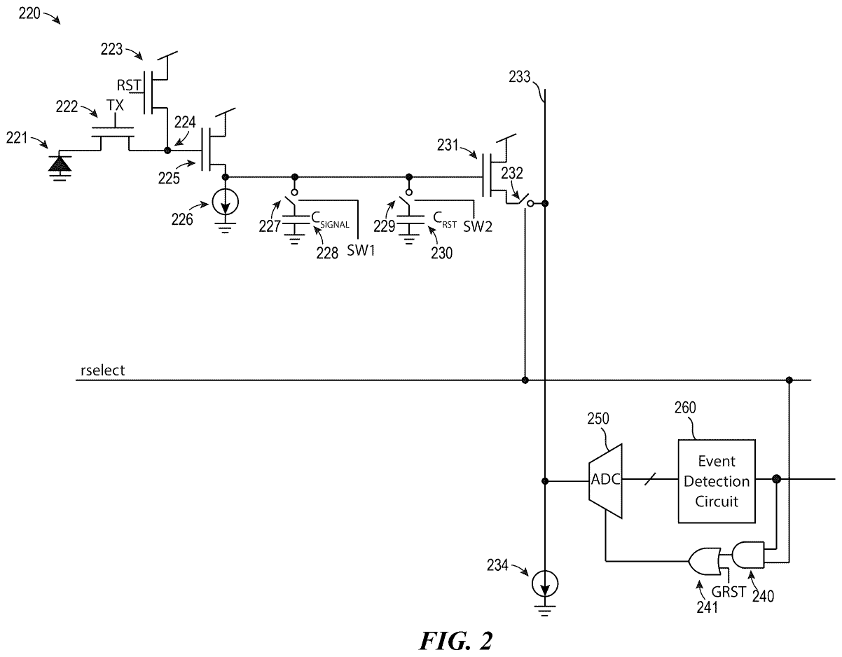

FIG. 2 is a partially schematic circuit diagram of an event vision sensor (EVS) pixel 220 configured in accordance with various embodiments of the present technology. The EVS pixel 220 can be an example of one of the pixels of the pixel array 108 of FIG. 1 or of other EVS pixels configured in accordance with various embodiments of the present technology. As shown, the EVS pixel 220 includes a photosensor 221, an integrating-type photo-detecting stage, in-pixel sampling circuitry, an analog-to-digital converter 250 (“ADC 250”), an event detection circuit 260, and reset circuitry. In the illustrated embodiment, the reset circuitry includes an AND logic gate 240 and an OR logic gate 241.

In some embodiments, the photosensor 221 includes a photodiode or another suitable type of photosensor. As a specific example, the photosensor 221 includes a pinned photodiode. In operation, the photosensor 221 is configured to photogenerate image charge based at least in part on light incident on the photosensor 221 from an external scene.

The integrating-type photo-detecting stage includes a transfer transistor 222 selectively coupling (and thereby selectively transferring image charge photogenerated by) the photosensor 221 to a floating diffusion 224 based at least in part on a transfer signal TX. The integrating-type photo-detecting stage further includes a reset transistor 223, a first source follower transistor 225. The reset transistor 223 is configured to selectively couple the floating diffusion 224 to a power supply voltage (and thereby reset a voltage at the floating diffusion 224) based at least in part on a reset signal RST. When the reset transistor 223 and the transfer transistor 222 are simultaneously in an activated state, the photosensor 221 can additionally be coupled to the power supply voltage via the transfer transistor 222 and the reset transistor 223.

The first source follower transistor 225 is coupled between the power supply voltage and ground, and includes a gate coupled to the floating diffusion 224. More specifically, the first source follower transistor 225 is coupled between the power supply and a first current source 226, and the first current source 226 is coupled between the first source follower transistor 225 and ground. The first source follower transistor 225 is configured to produce an analog voltage signal at its source based at least in part on a voltage at the floating diffusion 224 that is applied to the gate of the first source follower transistor 225.

The in-pixel sampling circuitry includes a first sampling node and a second sampling node. The first sampling node is shown with a first switch 227 and a first capacitor 228. A first terminal (or plate) of the first capacitor 228 is coupled to the first switch 227, and a second terminal (or plate) of the first capacitor 228 is coupled to ground. The first switch 227 can be controlled using a control signal SW1. When the control signal SW1 is asserted, the first switch 227 can couple the first terminal of the first capacitor to the source of the first source follower transistor 225 and to a gate of a second source follower transistor 231.

The second sampling node is shown with a second switch 229 and a second capacitor 230. A first terminal (or plate) of the second capacitor 230 is coupled to the second switch 229, and a second terminal (or plate) of the second capacitor 230 is coupled to ground. The second switch 229 can be controlled using a control signal SW2. When the control signal SW2 is asserted, the second switch 229 can couple the first terminal of the second capacitor 230 to the source of the first source follower transistor 225 and to a gate of a second source follower transistor 231.

The EVS pixel 220 further includes a second source follower transistor 231 having a gate (a) coupled to a source of the first source follower transistor 225 and (b) selectively coupled to the first and second capacitors 228, 230 via the first and second switches 227, 229, respectively. The second source follower transistor 231 further includes a drain coupled to the power supply voltage, and a source selectively coupled to a readout line 233 via a third switch 232. In operation, the second source follower transistor 231 is configured to produce an analog signal at its source based at least in part on a voltage applied to its gate. The output of the second source follower transistor 231 is controlled by the third switch 232, which may be governed by a row select signal rselect. More specifically, when activated, the third switch 232 can connect the source of the second source follower transistor 231 to the readout line 233 such that analog signals produced at the source of the second source follower transistor 231 can be passed onto the readout line 233. A second current source 234 is shown connected to the readout line 233.

In the illustrated embodiment, the readout line 233 feeds into the ADC 250. As discussed in greater detail below, the ADC 250 is configured to convert analog signals received from the source of the second source follower transistor 231 into corresponding digital signals. Outputs of the ADC 250 are connected to the event detection circuit 260.

The ADC 250 may be implemented as a pixel-level ADC, a cluster-level ADC, or a peripheral-level ADC. When implemented as a pixel-level ADC, the ADC 250 can be dedicated to a single (e.g., only one) pixel, such as the EVS pixel 220 illustrated in FIG. 2. Thus, in some such implementations, each EVS pixel employed by a corresponding event vision sensor can include its own unique instance of the ADC 250. It is expected that use of pixel-level ADCs will enable fast, asynchronous readout.

When implemented as a cluster-level ADC, the ADC 250 can be shared amongst a group (or cluster) of EVS pixels (e.g., including the EVS pixel 220 of FIG. 2). The group of EVS pixels can include two or more EVS pixels arranged in different rows of a corresponding event driven sensing array. Additionally, or alternatively, the group of EVS pixels can include two or more EVS pixels arranged in different columns of a corresponding event driven sensing array. In some embodiments, when using cluster-level ADC, EVS pixels can be read out row-by-row during a preset evaluation period, with readout of each row being allocated a same amount of time. In some such embodiments, EVS pixel rows that do not include any EVS pixels that detected events can be skipped during the readout process. It is expected that use of pixel-level ADCs and/or cluster-level ADCs will facilitate achieving desired latency goals of approximately 100 ns or less line-time.

When implemented as a peripheral-level ADC, the ADC 250 can be shared amongst all or large subsets of EVS pixels of a corresponding event driven sensing array. It is expected that use of a peripheral-level ADC may reduce or minimize EVS pixel footprint but at a cost of increased latency.

In some embodiments, the ADC 250 can be configured with desired capabilities. For example, the ADC 250 can have a signal-to-noise ratio (SNR) rating of approximately 76 dB and/or a 13-bit resolution in 100 μs or less. Such a resolution is expected to handle a large dynamic range of input signals. In other embodiments, a smaller ADC resolution can be used for smaller dynamic ranges of input signals (e.g., that are achieved using exposure control techniques in combination with cluster-level or pixel-level ADCs). In these and still other embodiments, the ADC 250 can be a compressive or nonlinear ADC. Additionally, or alternatively, the ADC 250 can be configured as a ramp converter. In these and other embodiments, the ADC 250 can be selectively powered down (e.g., during exposure/integration periods, such as for the photosensor 221), such as to reduce power consumption and/or conserve power (e.g., in situations in which latency requirements are low).

As discussed in greater detail below, the event detection circuit 260 can be configured to perform correlated doubling sampling operations, compute one or more differences between corresponding digital signals, and compare digital difference signals to a contrast threshold to generate event signals indicative of whether the EVS pixel 220 has detected an event in an external scene monitored by the EVS pixel 220. In the illustrated embodiment, the output of the event detection circuit 260 is connected to the AND logic gate 240. The AND logic gate 240 may be further configured to receive the row select signal rselect. Thus, an output of the AND logic gate 240 can be asserted when the output of the event detection circuit 260 is asserted (indicating that the EVS pixel 220 has detected an event) while the row select signal rselect is also asserted. The output of the AND logic gate 240 can be coupled to an input of the OR logic gate 241. Another input of the OR logic gate 241 may receive a global reset signal GRST. Thus, an output of the OR logic gate 241 can be asserted when the output of the AND logic gate 240 is asserted or when the global reset signal GRST is asserted. The output of the OR logic gate 241 can be coupled to the ADC 250. As discussed in greater detail below, the output of the OR logic gate 241 can be used to transition the EVS pixel 220 between phases of operation, such as from a second phase of operation to a first phase of operation.

Although not shown in the illustrated embodiment, the EVS pixel 220 can include several components in addition to the components illustrated in FIG. 2. For example, the EVS pixel 220 can be configured as (and therefore include corresponding circuit components for) a high dynamic range (HDR) pixel. Additionally, or alternatively, the EVS pixel 220 can be configured as (and therefore include corresponding circuit components for) a dual conversion gain (DGC) pixel. In these and still other embodiments, the EVS pixel 220 can be configured as (and therefore include corresponding circuit components for) a lateral-overflow-integration-capacitor-type (“LOFIC-type”) pixel. The DCG pixel and/or the LOFIC-type pixel can be achieved by selectively extending (or used to selectively extend) the charge capacity of the floating diffusion 224.

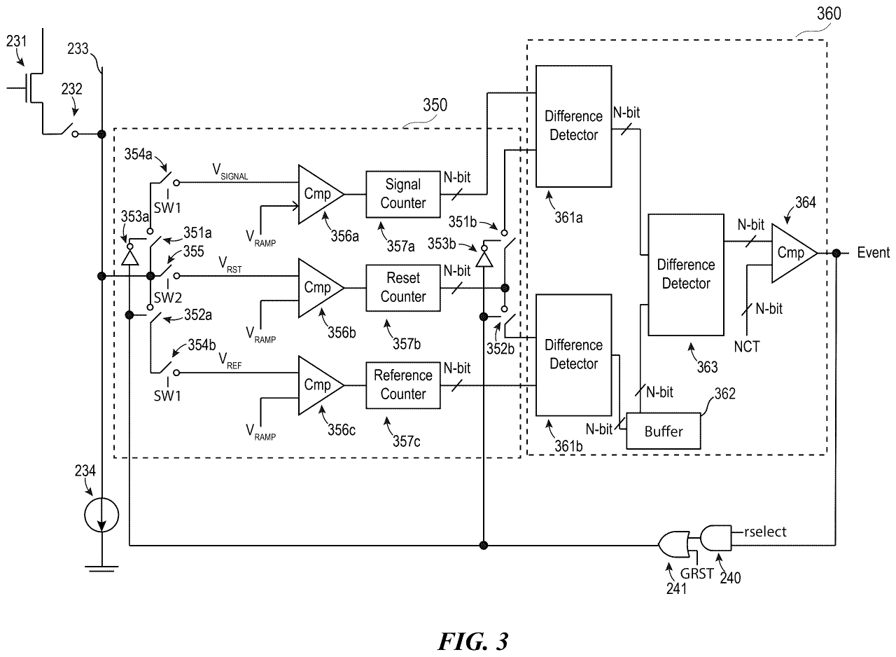

FIG. 3 is a partially schematic circuit diagram of an analog-to-digital converter 350 (“ADC 350”) and an event detection circuit 360, each configured in accordance with various embodiments of the present technology. The ADC 350 can be an example of the ADC 250 of FIG. 2, and the event detection circuit 360 can be an example of the event detection circuit 260 of FIG. 2. Indeed, the ADC 350 and the event detection circuit 360 are illustrated in FIG. 3 as being coupled to the second source follower transistor 231, the third switch 232, the readout line 233, the second current source 234, the AND logic gate 240, and the OR logic gate 241 that were each discussed above with reference to FIG. 2. Alternatively, the ADC 350 and/or the event detection circuit 360 can be an example of other ADCs and/or other event detection circuitry, respectively, configured in accordance with various embodiments of the present technology.

In the illustrated embodiment, the ADC 350 includes an input coupled to the readout line 233, a first switch 351a, a second switch 352a, a first inverter 353a, a third switch 354a, a fourth switch 354b, a fifth switch 355, a first comparator 356a, a second comparator 356b, a third comparator 356c, a first counter 357a, a second counter 357b, a third counter 357c, a sixth switch 351b, a seventh switch 352b, and a second inverter 353b. The event detection circuit 360 is coupled to outputs of the ADC 350 and includes a first difference detector circuit 361a, a second difference detector circuit 361b, a buffer 362, a third difference detector circuit 363, and a comparator 364.

In some cases, the first switch 351a and the sixth switch 351b may be controlled by the first inverter 353a and the second inverter 353b, respectively, and by the output of the OR gate 241. The second switch 352a and the seventh switch 352b may be controlled by the output of the OR gate 241. The third switch 354a, the fourth switch 354b, and the fifth switch 355 may control signal routing within the ADC 350, such as based on control signals SW1 and SW2 (e.g., the same control signals or different control signals as those used to control the first and second switches 227, 229 of the in-pixel sampling circuitry described above with reference to FIG. 2).

The first comparator 356a, the second comparator 356b, and the third comparator 356c may be connected to the first counter 357a, the second counter 357b, and the third counter 357c, respectively. These comparators and counters may work together to convert analog signals to digital signals.

In some cases, the first difference detector circuit 361a, the second difference detector circuit 361b, and/or the third difference detector circuit 363 of the event detection circuit 360 may be full adder, full subtractor, or half subtractor circuits. The buffer 362 may be a pixel-level buffer dedicated to only the EVS pixel 220, or a cluster-level buffer dedicated to a group of EVS pixels including the EVS pixel 220. In some cases, the buffer 362 may be a peripheral-level buffer corresponding to all or a large subset of EVS pixels of an event vision sensor or hybrid image sensor.

In some embodiments, all or a subset of the event detection circuit 360 can be configured as column-level circuitry. In other embodiments, all or a subset of the event detection circuit 360 can be configured as pixel-level circuitry (e.g., dedicated to a single or only one EVS pixel) or as cluster-level circuitry (e.g., dedicated to a group/cluster/subset of EVS pixels of a corresponding event driven sensing array.

Operation of the ADC 350 and the event detection circuit 360 will now be described with reference to FIGS. 2 and 3 together. The EVS pixel 220, the ADC 350, and the event detection circuit 360 are configured to operate in different phases (or modes) to process analog signals received via the readout line 233. A current phase/mode of the ADC 350 and the event detection circuit 360 can be governed by the output of the OR logic gate 241, the first switch 351a, the second switch 352a, the sixth switch 351b, the seventh switch 352b, the first inverter 353a, and/or the second inverter 353b. For example, the EVS pixel 220, the ADC 350, and the event detection circuit 360 may operate in a first phase or mode of operation when the output of the OR gate 241 is asserted such that the second switch 352a and the seventh switch 352b are activated while the first switch 351a and the sixth switch 351b are deactivated. As discussed above, the output of the OR logic gate 241 can be asserted when the global reset signal GRST is asserted or when the output of the AND logic gate 240 is asserted, which occurs when the output of the event detection circuit 360 is asserted (indicating that the EVS pixel 220 has detected an event) while the row select signal rselect is asserted. As another example, the EVS pixel 220, the ADC 350, and the event detection circuit 360 may operate in a second phase or mode of operation when the output of the OR gate 241 is de-asserted such that the second switch 352a and the seventh switch 352b are deactivated while the first switch 351a and the sixth switch 351b are activated.

In some embodiments, the EVS pixel 220, the ADC 350, and the event detection circuit 360 can be configured to sample an integrated reference irradiance level and obtain a corresponding digital representation when operating in the first mode of operation. For example, referring to FIG. 2, when in the first mode of operation, the transfer control signal TX and the control signal SW1 can be asserted for a period delta_t while the reset control signal RST, the control signal SW2, and the row select signal rselect are de-asserted. As such, image charge photogenerated by the photosensor 221 during the period delta_t can accumulate at the floating diffusion 224. In turn, the first source follower transistor 225 produces an analog voltage signal at its source, which is copied onto the first capacitor 228 of the first node of the in-pixel sampling circuitry of the EVS pixel 220. The analog voltage signal produced at the source of the first source follower transistor 225 can correspond to the voltage at the floating diffusion 224, which is based at least in part on image charge photogenerated by the photosensor 221 during the period delta_t.

At the end of the period delta_t, the control signal SW1 can be de-asserted, thereby uncoupling the first capacitor 228 from the source of the first source follower transistor 225 such that an integrated reference irradiance level sampled onto the first capacitor 228 no longer follows the voltage at the source of the first source follower transistor 225. A voltage (also referred to herein as a “reference level signal”) sampled onto the first capacitor 228 at the end of the period delta_t can be inclusive of the integrated reference irradiance level and a noise component, such as due to fixed pattern noise (FPN), kTC noise, etc. Thus, the second node of the in-pixel sampling circuit can be used to sample the noise component for a correlated double sampling (CDS) operation performed downstream to isolate the integrated reference irradiance level.

For example, the reset control signal RST can be asserted to couple the floating diffusion 224 to the power supply voltage. During this time, the transfer control signal TX may or may not be asserted. A voltage at the floating diffusion 224 is therefore reset, and the first source follower transistor 225 produces an analog signal at its source corresponding to the reset voltage level at the floating diffusion. This analog signal (also referred to herein as a “first noise level,” a “first noise signal,” a “first reset level,” and the like) can be copied onto the second capacitor 230 via the second switch 229 by asserting the control signal SW2. The control signal SW2 can thereafter be de-asserted to deactivate the second switch 229 such that the first reset level sampled onto the second capacitor 230 no longer follows the voltage produced at the source of the first source follower transistor 225. The control signal SW2 can be activated and/or deactivated while the reset control signal RST and/or the transfer control signal TX remain asserted. Alternatively, the control signal SW2 can be activated and/or deactivated after the reset control signal RST and/or the transfer control signal TX have been de-asserted.

The reference level signal and the first reset level can then be sequentially read out onto the readout line 233 and converted into digital signals using the ADC 250/350. For example, the control signal SW2 can be asserted to couple the second capacitor 230 to the gate of the second source follower transistor 231 while the row select signal rselect is asserted to activate the third switch 232 and couple the source of the second source follower transistor 231 to the readout line 233. In turn, the second source follower transistor 231 can produce an analog signal at its output corresponding to the first reset level sampled on the second capacitor 230. The analog signal can be output, via the third switch 232, onto the readout line 233 and fed into the ADC 250/350.

Referring to FIG. 3, because the ADC 350 is currently operating in the first phase or mode of operation, the second switch 352a is activated while the first switch 351a is deactivated. In addition, the control signal SW2 is asserted (e.g., as part of coupling the second capacitor 230 of FIG. 2 to the gate of the second source follower transistor 231), meaning that the fifth switch 355 is activated. As a result, the analog signal corresponding to the first reset level (also referred to herein as the “analog first reset level signal”) is routed from the readout line 233 to a first input of the second comparator 356b of the ADC 350.

In some embodiments, the ADC 350 can be configured as a ramp converter. For example, the second comparator 356b can be configured to compare the analog first reset level signal received at its first input to an analog ramp signal VRAMP fed into its second input. The analog ramp signal VRAMP fed into its second input can be based on a count maintained and incremented by the second counter 357b. More specifically, when the analog first reset level signal is read onto the readout line 233 via the third switch 232, the second counter 357b can begin incrementing a count up from zero, which can be converted into the analog ramp signal VRAMP by a digital-to-analog converter (not shown). The analog ramp signal VRAMP is ramped as the count increases. When the analog ramp signal VRAMP is equal to or greater than the analog first reset level signal fed into the first input of the second comparator 356b via the readout line 233, the output of the second comparator 356b flips and the second counter 357b stops counting. The digital output of the second counter 357b (e.g., an n-bit value) can be output to a first input of the second difference detector circuit 361b of the event detection circuit 360 via the seventh switch 352b, which is activated while the sixth switch 351b is deactivated due to the ADC 350 currently operating in the first phase or mode of operation. The digital output of the second counter 357b is also referred to herein as a digital first reset level signal.

Referring again to FIG. 2, the control signal SW2 can be de-asserted, and the control signal SW1 can be asserted to couple the first capacitor 228 to the gate of the second source follower transistor 231 while the row select signal rselect is asserted to activate the third switch 232 and couple the source of the second source follower transistor 231 to the readout line 233. In turn, the second source follower transistor 231 can produce an analog signal at its output corresponding to the reference level signal sampled on the first capacitor 228. The analog signal (also referred to herein as an “analog reference level signal”) produced at the source of the second source follower transistor 231 can be output, via the third switch 232, onto the readout line 233 and fed into the ADC 250/350.

Referring again to FIG. 3, because the ADC 350 is operating in the first phase or mode of operation, the second switch 352a is activated while the first switch 351a is deactivated. In addition, the control signal SW1 is asserted (e.g., as part of coupling the first capacitor 228 of FIG. 2 to the gate of the second source follower transistor 231), meaning that the fourth switch 354b is activated. As a result, the analog reference level signal is routed from the readout line 233 to a first input of the third comparator 356c of the ADC 350.

Similar to the second comparator 356b, the third comparator 356c can be configured as part of a ramp converter. Thus, the third comparator 356c can compare the analog reference level signal received at its first input to an analog ramp signal VRAMP fed into its second input. The analog ramp signal VRAMP fed into its second input can be based on a count maintained and incremented by the third counter 357c. More specifically, when the analog reference level signal is read onto the readout line 233 via the third switch 232, the third counter 357c can begin incrementing a count up from zero, which can be converted into the analog ramp signal VRAMP by a digital-to-analog converter (not shown). The analog ramp signal VRAMP is ramped as the count increases. When the analog ramp signal VRAMP is equal to or greater than the analog reference level signal fed into the first input of the third comparator 356c via the readout line 233, the output of the third comparator 356c flips and the third counter 357c stops counting. The digital output of the third counter 357c (e.g., an n-bit value) can be output to a second input of the second difference detector circuit 361b of the event detection circuit 360. The digital output of the third counter 357c is also referred to herein as a digital reference level signal.

In turn, the second difference detector circuit 361b can perform a correlated double sampling (CDS) operation to factor out (e.g., reduce, minimize, eliminate) a noise component in the digital reference level signal (e.g., to isolate a digital representation of the integrated reference irradiance level sampled onto the first capacitor 228 of the first node of the in-pixel sampling circuitry during the period delta_t). For example, the second difference detector circuit 361b can compute a first digital difference signal representing a difference between (a) the digital reference level signal received at its second input from the third counter 357c of the ADC 350 and (b) the digital first reset level signal received at its first input from the second counter 357b of the ADC 350. The first digital difference signal can be an N-bit digital signal indicative of the integrated reference irradiance level. As shown in FIG. 3, the second difference detector circuit 361b can output the first digital difference signal to the buffer 362 of the event detection circuit 360 for storage for later use by the third difference detector circuit 363.

The output of the OR logic gate 241 can be de-asserted, thereby transitioning the EVS pixel 220, the ADC 350, and/or the event detection circuit 360 from the first phase/mode of operation to the second phase/mode of operation. As shown in FIG. 3, when the output of the OR logic gate 241 is de-asserted, the second switch 352a and the seventh switch 352b can be deactivated, and the first switch 351a and the sixth switch 351b can be activated.

In some embodiments, the EVS pixel 220, the ADC 350, and the event detection circuit 360 can be configured to sample a momentary integrated signal irradiance level and obtain a corresponding digital representation when operating in the second mode of operation. For example, referring to FIG. 2, when in the second mode of operation, the transfer control signal TX and the control signal SW1 can be asserted for an exposure period t while the reset control signal RST, the control signal SW2, and the row select signal rselect are de-asserted. As such, image charge photogenerated by the photosensor 221 during the exposure period t can accumulate at the floating diffusion 224. In turn, the first source follower transistor 225 produces an analog voltage signal at its source, which is copied onto the first capacitor 228 of the first node of the in-pixel sampling circuitry of the EVS pixel 220. The analog voltage signal produced at the source of the first source follower transistor 225 can correspond to the voltage at the floating diffusion 224, which is based at least in part on image charge photogenerated by the photosensor 221 during the exposure period t.

At the end of the exposure period t, the control signal SW1 can be de-asserted, thereby uncoupling the first capacitor 228 from the source of the first source follower transistor 225 such that a momentary integrated signal irradiance level sampled onto the first capacitor 228 no longer follows the voltage at the source of the first source follower transistor 225. A voltage (also referred to herein as a “signal level signal”) sampled onto the first capacitor 228 at the end of the exposure period t can be inclusive of the momentary integrated signal irradiance level and a noise component, such as due to fixed pattern noise (FPN), kTC noise, etc. Thus, the second node of the in-pixel sampling circuit can be used to sample the noise component for a correlated double sampling (CDS) operation performed downstream to isolate the momentary integrated signal irradiance level.

For example, the reset control signal RST can be asserted to couple the floating diffusion 224 to the power supply voltage. During this time, the transfer control signal TX may or may not be asserted. A voltage at the floating diffusion 224 is therefore reset, and the first source follower transistor 225 produces an analog signal at its source corresponding to the reset voltage level at the floating diffusion. This analog signal (also referred to herein as a “second noise level,” a “second noise signal,” a “second reset level,” and the like) can be copied onto the second capacitor 230 via the second switch 229 by asserting the control signal SW2. The control signal SW2 can thereafter be de-asserted to deactivate the second switch 229 such that the second reset level sampled onto the second capacitor 230 no longer follows the voltage produced at the source of the first source follower transistor 225. The control signal SW2 can be activated and/or deactivated while the reset control signal RST and/or the transfer control signal TX remain asserted. Alternatively, the control signal SW2 can be activated and/or deactivated after the reset control signal RST and/or the transfer control signal TX have been de-asserted.

The reference level signal and the first reset level can then be sequentially read out onto the readout line 233 and converted into digital signals using the ADC 250/350. For example, the control signal SW2 can be asserted to couple the second capacitor 230 to the gate of the second source follower transistor 231 while the row select signal rselect is asserted to activate the third switch 232 and couple the source of the second source follower transistor 231 to the readout line 233. In turn, the second source follower transistor 231 can produce an analog signal at its output corresponding to the second reset level sampled on the second capacitor 230. The analog signal can be output, via the third switch 232, onto the readout line 233 and fed into the ADC 250/350.

Referring to FIG. 3, because the ADC 350 is currently operating in the second phase or mode of operation, the first switch 351a is activated while the second switch 352a is deactivated. In addition, the control signal SW2 is asserted (e.g., as part of coupling the second capacitor 230 of FIG. 2 to the gate of the second source follower transistor 231), meaning that the fifth switch 355 is activated. As a result, the analog signal corresponding to the second reset level (also referred to herein as the “analog second reset level signal”) is routed from the readout line 233 to the first input of the second comparator 356b of the ADC 350.

As discussed above, the ADC 350 can be configured as a ramp converter. For example, the second comparator 356b can be configured to compare the analog second reset level signal received at its first input to an analog ramp signal VRAMP fed into its second input. The analog ramp signal VRAMP fed into its second input can be based on a count maintained and incremented by the second counter 357b. More specifically, when the analog second reset level signal is read onto the readout line 233 via the third switch 232, the second counter 357b can begin incrementing a count up from zero, which can be converted into the analog ramp signal VRAMP by a digital-to-analog converter (not shown). The analog ramp signal VRAMP is ramped as the count increases. When the analog ramp signal VRAMP is equal to or greater than the analog second reset level signal fed into the first input of the second comparator 356b via the readout line 233, the output of the second comparator 356b flips and the second counter 357b stops counting. The digital output of the second counter 357b (e.g., an n-bit value) can be output to a first input of the first difference detector circuit 361a of the event detection circuit 360 via the sixth switch 351b, which is activated while the seventh switch 352b is deactivated due to the ADC 350 currently operating in the second phase or mode of operation. The digital output of the second counter 357b is also referred to herein as a digital second reset level signal.

Referring again to FIG. 2, the control signal SW2 can be de-asserted, and the control signal SW1 can be asserted to couple the first capacitor 228 to the gate of the second source follower transistor 231 while the row select signal rselect is asserted to activate the third switch 232 and couple the source of the second source follower transistor 231 to the readout line 233. In turn, the second source follower transistor 231 can produce an analog signal at its output corresponding to the signal level signal sampled on the first capacitor 228. The analog signal (also referred to herein as an “analog signal level signal”) produced at the source of the second source follower transistor 231 can be output, via the third switch 232, onto the readout line 233 and fed into the ADC 250/350.

Referring again to FIG. 3, because the ADC 350 is operating in the second phase or mode of operation, the first switch 351a is activated while the second switch 352a is deactivated. In addition, the control signal SW1 is asserted (e.g., as part of coupling the first capacitor 228 of FIG. 2 to the gate of the second source follower transistor 231), meaning that the third switch 354a is activated. As a result, the analog signal level signal is routed from the readout line 233 to a first input of the first comparator 356a of the ADC 350.

Similar to the second comparator 356b and the third comparator 356c discussed above, the first comparator 356a can be configured as part of a ramp converter. Thus, the first comparator 356a can compare the analog signal level signal received at its first input to an analog ramp signal VRAMP fed into its second input. The analog ramp signal VRAMP fed into its second input can be based on a count maintained and incremented by the first counter 357a. More specifically, when the analog signal level signal is read onto the readout line 233 via the third switch 232, the first counter 357a can begin incrementing a count up from zero, which can be converted into the analog ramp signal VRAMP by a digital-to-analog converter (not shown). The analog ramp signal VRAMP is ramped as the count increases. When the analog ramp signal VRAMP is equal to or greater than the analog signal level signal fed into the first input of the first comparator 356a via the readout line 233, the output of the first comparator 356a flips and the first counter 357a stops counting. The digital output of the first counter 357a (e.g., an n-bit value) can be output to a second input of the first difference detector circuit 361a of the event detection circuit 360. The digital output of the first counter 357a is also referred to herein as a digital signal level signal.

In turn, the first difference detector circuit 361a can perform a correlated double sampling (CDS) operation to factor out (e.g., reduce, minimize, eliminate) a noise component in the digital signal level signal (e.g., to isolate a digital representation of the momentary integrated signal irradiance level sampled onto the first capacitor 228 of the first node of the in-pixel sampling circuitry during the exposure period t). For example, the first difference detector circuit 361a can compute a second digital difference signal representing a difference between (a) the digital signal level signal received at its second input from the first counter 357a of the ADC 350 and (b) the digital second reference level signal received at its first input from the second counter 357b of the ADC 350. The second digital difference signal can be an N-bit digital signal indicative of the momentary integrated signal irradiance level. As shown in FIG. 3, the first difference detector circuit 361a can output the second digital difference signal to the third difference detector circuit 363 of the event detection circuit 360.

The third difference detector circuit 363 can retrieve and/or receive the first digital difference signal stored to the buffer 362. In turn, the third difference detector circuit 363 can compute a difference between (a) the second digital difference signal received from the first difference detector circuit 361a and (b) the first digital difference signal stored to the buffer 362. As the second digital difference signal represents a momentary integrated signal irradiance level and the first digital difference signal represents an integrated reference irradiance level, the difference computed by the third difference detector circuit 363 can represent a difference between the momentary integrated signal irradiance level and the integrated reference irradiance level. In other words, the difference computed by the third difference detector circuit 363 can be a temporal contrast difference in light incident on the photosensor 221 of the pixel 220 of FIG. 2. The difference computed by the third difference detector circuit 363 can be an N-bit digital value, and is also referred to herein as a “third digital difference signal,” a “temporal contrast difference,” and the like. The third digital difference signal is output from the third difference detector circuit 363 to a first input of the comparator 364 of the event detection circuit 360.

The comparator 364 is configured to compare the third digital difference signal received at its first input to a nominal contrast threshold (NCT) received at its second input. The NCT can be an N-bit digital value. In some embodiments, the NCT corresponds to a (e.g., preset and/or programmable) contrast threshold value that provides a 50% fire probability for UP events and a 50% first probability for DOWN events. In the illustrated embodiment, the NCT is a unified NCT value that is used to detect both UP events and DOWN events.

The comparator 364 is configured to assert an event signal Event output from the event detection circuit 360 when the third digital difference signal is greater than or equal to the NCT. Assertion of the event signal Event can indicate that the EVS pixel 220 coupled to the event detection circuit 360 detected an event in the external scene during the exposure period t. The asserted event signal Event output from the event detection circuit 360 can be passed to reset circuitry (e.g., an input of the AND logic gate 240) of the corresponding EVS pixel. As discussed above, the AND logic gate 240 can receive the event signal Event at one of its inputs and the row select signal rselect at another of its inputs. When both the event signal Event and the row select signal rselect are asserted at the same time, the output of the AND logic gate 240 is asserted, which cause the output of the OR logic gate 241 to be asserted. In turn, the EVS pixel 220, the ADC 350, and/or the event detection circuit 360 are transitioned from the second phase/mode of operation to the first phase/mode of operation. As a result, the first digital difference signal stored to the buffer 362 can be updated to represent a new integrated reference irradiance level in a manner consistent with the discussion above with reference to the first phase/mode of operation.

On the other hand, the comparator 364 is configured to de-assert the event signal Event (or keep the event signal Event de-asserted) when the third digital difference signal is not greater than (e.g., is lesser than or equal to) the NCT. As a result, the output of the AND logic gate 240 remains de-asserted, keeping the output of the OR logic gate de-asserted. Thus, the EVS pixel 220, the ADC 350, and/or the event detection circuit 360 remain in the second phase/mode of operation; the buffer 362 maintain the same integrated reference irradiance level as the first digital difference signal; and the EVS pixel 220, the ADC 350, and/or the event detection circuit 360 (a) sample a new momentary integrated signal irradiance level during a next exposure period t and (b) compare it to the first digital difference signal representing the same integrated reference irradiance level. As a result, the integrated reference irradiance level stored as the first digital difference signal in the buffer 362 is not updated to reflect a new integrated reference irradiance level until either the EVS pixel 220 detects an event during an exposure period t or the global reset signal GRST is asserted.

Although shown in FIG. 3 with a single (e.g., only one) instance of a comparator 364, event detection circuits 360 of the present technology are not so limited. For example, in other embodiments, an event detection circuit can include multiple instances of comparators (similar to the comparator 364). As a specific example, an event detection circuit of the present technology can include two instances of comparators (similar to the comparator 364 that each include an input coupled to the output of the difference detector circuit 363. Continuing with this example, the N-bit difference signal output from the difference detector circuit 363 can be fed into the first comparator for comparison to a first NCT signal, such as an NCT signal NCT_up used for detecting UP events (e.g., changes in contrast from darker to brighter). In addition, the N-bit difference signal output from the difference detector circuit 363 can be fed into the second comparator for comparison to a second NCT signal, such as an NCT signal NCT_dn used for detecting DOWN events (e.g., changes in contrast from brighter to darker). The first NCT signal and the second NCT signal can correspond to the same or difference threshold values.

In some embodiments, the event detection circuit in the above example can be configured to output the output of the first comparator and the output of the second comparator as separate signals. This can enable downstream circuitry to determine whether the corresponding circuitry detected an UP event or a DOWN event. For example, when an output of the first comparator is asserted, this can indicate that the difference signal output from the difference detector circuit 363 was positive and/or had a magnitude greater than the first NCT signal (e.g., indicating detection of an UP event). As another example, when an output of the second comparator is asserted, this can indicate that the difference signal output from the difference detector circuit 363 was negative and/or had a magnitude greater than the second NCT signal (e.g., indicating detection of a DOWN event).

In these and other embodiments, the outputs of the first and second comparators can be combined, such as to control reset circuitry (e.g., the AND logic gate 240 and/or the OR logic gate 241) of the corresponding pixel. As a specific example, the event signal Event output from the event detection circuit can depend based at least in part on the outputs of the first and second comparators. More specifically, the event signal Event output from the event detection circuit can be asserted when (a) the output of the first comparator is asserted (indicating that the difference signal output from the difference detector circuit 363 was positive and/or had a magnitude greater than the first NCT signal, which can indicate detection of an UP event) and/or (b) the output of the second comparator is asserted (indicating that the difference signal output from the difference detector circuit 363 was negative and/or had a magnitude greater than the second NCT signal, which can indicate detection of a DOWN event). In other words, the event signal Event can be asserted when either the output of the first comparator is asserted or the output of the second comparator is asserted. Thus, in some embodiments, the outputs of the first and second comparators can be fed into an OR logic gate (e.g., of the event detection circuit 360), and the output of the OR logic gate can be fed into an input of the AND logic gate 240 of reset circuitry of the corresponding pixel.

Furthermore, although discussed in detail above and illustrated in FIG. 2 as (a) using the first switch 227 and the first capacitor 228 (e.g., the first node) of the in-pixel sampling circuitry for sampling integrated irradiance levels and (b) using the second switch 229 and the second capacitor 230 (e.g., the second node) of the in-pixel sampling circuitry for sampling reset levels in both the first phase/mode of operation and the second phase/mode of operation, the present technology is not so limited. In other embodiments, the first switch 227 and the first capacitor 228 (e.g., the first node) of the in-pixel sampling circuitry can be used for sampling reset levels in both the first mode and the second mode, and the second switch 229 and the second capacitor 230 (e.g., the second node) of the in-pixel sampling circuitry can be used for sampling integrated irradiance levels in both the first mode and the second mode. As another example, the first switch 227 and the first capacitor 228 (e.g., the first node) of the in-pixel sampling circuitry can be used for sampling reset levels in the first mode and for sampling integrated irradiance levels in the second mode, and the second switch 229 and the second capacitor 230 (e.g., the second node) of the in-pixel sampling circuitry can be used for sampling integrated irradiance levels in the first mode and for sampling reset levels the second mode. As still another example, the first switch 227 and the first capacitor 228 (e.g., the first node) of the in-pixel sampling circuitry can be used for sampling reset levels in the second mode and for sampling integrated irradiance levels in the first mode, and the second switch 229 and the second capacitor 230 (e.g., the second node) of the in-pixel sampling circuitry can be used for sampling integrated irradiance levels in the second mode and for sampling reset levels the first mode.

### C. Conclusion

The above detailed descriptions of embodiments of the technology are not intended to be exhaustive or to limit the technology to the precise form disclosed above. Although specific embodiments of, and examples for, the technology are described above for illustrative purposes, various equivalent modifications are possible within the scope of the technology as those skilled in the relevant art will recognize. For example, although steps are presented in a given order above, alternative embodiments may perform steps in a different order. Furthermore, the various embodiments described herein may also be combined to provide further embodiments.

From the foregoing, it will be appreciated that specific embodiments of the technology have been described herein for purposes of illustration, but well-known structures and functions have not been shown or described in detail to avoid unnecessarily obscuring the description of the embodiments of the technology. To the extent any material incorporated herein by reference conflicts with the present disclosure, the present disclosure controls. Where context permits, singular or plural terms may also include the plural or singular term, respectively. In addition, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Moreover, as used herein, the phrases “based on,” “depends on,” “as a result of,” and “in response to” shall not be construed as a reference to a closed set of conditions. For example, an exemplary step that is described as “based on condition A” may be based on both condition A and condition B without departing from the scope of the present disclosure. In other words, as used herein, the phrase “based on” shall be construed in the same manner as the phrase “based at least in part on” or the phrase “based at least partially on.” Also, the terms “connect” and “couple” are used interchangeably herein and refer to both direct and indirect connections or couplings. For example, where the context permits, element A “connected” or “coupled” to element B can refer (i) to A directly “connected” or directly “coupled” to B and/or (ii) to A indirectly “connected” or indirectly “coupled” to B.

From the foregoing, it will also be appreciated that various modifications may be made without deviating from the disclosure or the technology. For example, one of ordinary skill in the art will understand that various components of the technology can be further divided into subcomponents, or that various components and functions of the technology may be combined and integrated. In addition, certain aspects of the technology described in the context of particular embodiments may also be combined or eliminated in other embodiments. Furthermore, although advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

What is claimed is:

1. An image sensor, comprising:
an event vision sensor (EVS) pixel including a photosensor, an integrating-type photo-detecting stage, and in-pixel sampling circuitry including a plurality of sampling nodes;
an analog-to-digital converter (ADC) coupled to the in-pixel sampling circuitry and configured to convert analog irradiance levels output by the in-pixel sampling circuitry into digital signals; and
event detection circuitry coupled to the ADC and configured to compute event signals based at least in part on (i) temporal contrast differences between corresponding digital signals output by the ADC and (ii) a contrast threshold.

2. The image sensor of claim 1, wherein the plurality of sampling nodes includes a first sampling node configured to sample integrated irradiance levels and a second sampling node configured to sample reset level signals.

3. The image sensor of claim 2, wherein the first sampling node is configured to sample an integrated reference irradiance level during a first phase of operation and a momentary integrated signal irradiance level during a second phase of operation.

4. The image sensor of claim 3, wherein the second sampling node is configured to sample a first reset level during the first phase of operation and a second reset level during the second phase of operation.

5. The image sensor of claim 4, wherein the event detection circuitry is configured to:
perform a first correlated double sampling operation using the integrated reference irradiance level and the first reset level to compute a first digital difference signal;
perform a second correlated double sampling operation using the momentary integrated signal irradiance level and the second reset level to compute a second digital difference signal; and
compute a temporal contrast difference between the first digital difference signal and the second digital difference signal.

6. The image sensor of claim 5, wherein the image sensor comprises a buffer configured to store the first digital difference signal.

7. The image sensor of claim 6, wherein the buffer is a pixel-level buffer that is dedicated to only the EVS pixel.

8. The image sensor of claim 6, wherein the buffer is a cluster-level buffer that is dedicated to a group of EVS pixels including the EVS pixel, and wherein the buffer is configured to store a corresponding first digital difference signal for each EVS pixel of the group including the first digital different signal for the EVS pixel.

9. The image sensor of claim 6, wherein the event detection circuitry is configured to assert an event signal when the temporal contrast difference is greater than or equal to the contrast threshold.

10. The image sensor of claim 9, further comprising reset circuitry usable to update the integrated reference irradiance level stored in the buffer based at least in part on assertion of the event signal.

11. The image sensor of claim 1, wherein the ADC is a pixel-level ADC dedicated to the EVS pixel.

12. The image sensor of claim 1, wherein the ADC is a cluster-level ADC shared by a group of EVS pixels including the EVS pixel.

13. The image sensor of claim 1, wherein the contrast threshold is programmable.

14. A method of operating an image sensor, the method comprising:
sampling, using in-pixel sampling circuitry of an event vision sensor (EVS) pixel, an integrated reference irradiance level during a first phase of operation;
sampling, using the in-pixel sampling circuitry, a momentary integrated signal irradiance level during a second phase of operation;
converting the integrated reference irradiance level and the momentary integrated signal irradiance level into corresponding digital signals;
computing a temporal contrast difference between the corresponding digital signals; and
asserting an event signal when the temporal contrast difference is greater than or equal to a contrast threshold.

15. The method of claim 14, further comprising:
sampling a first reset level during the first phase of operation; and
sampling a second reset level during the second phase of operation.

16. The method of claim 15, wherein converting the integrated reference irradiance level and the momentary integrated signal irradiance level into corresponding digital signals comprises:
performing a first correlated double sampling operation using the integrated reference irradiance level and the first reset level to compute a first digital difference signal; and
performing a second correlated double sampling operation using the momentary integrated signal irradiance level and the second reset level to compute a second digital difference signal.

17. The method of claim 16, wherein computing the temporal contrast difference comprises comparing the first digital difference signal to the second digital difference signal.

18. The method of claim 17, further comprising storing the first digital difference signal in a buffer.

19. The method of claim 18, wherein storing the first digital difference signal in the buffer includes storing the first digital difference signal in the buffer before sampling the a momentary integrated signal irradiance level and the second reset level.

20. The method of claim 18, further comprising updating the integrated reference irradiance level stored in the buffer based at least in part on assertion of the event signal.

21. The method of claim 14, wherein converting the integrated reference irradiance level and the momentary integrated signal irradiance level into corresponding digital signals comprises using a pixel-level analog-to-digital converter dedicated to the EVS pixel.

22. The method of claim 14, wherein converting the integrated reference irradiance level and the momentary integrated signal irradiance level into corresponding digital signals comprises using a cluster-level analog-to-digital converter shared by a group of EVS pixels including the EVS pixel.

23. An event vision sensor (EVS) pixel, comprising:
a photosensor configured to photogenerate image charge in response to light incident on the photosensor;
an integrating-type photo-detecting stage coupled to the photosensor; and
in-pixel sampling circuitry including a first node usable to sample integrated reference irradiance levels and a second node different from the first node and usable to sample reset levels corresponding to the integrated reference irradiance levels.

24. The EVS pixel of claim 23, wherein the integrating-type photo-detecting stage includes a floating diffusion, a reset transistor configured to selectively couple the floating diffusion to a power supply voltage, and a source follower transistor having a gate coupled to the floating diffusion.

25. The EVS pixel of claim 24, wherein the integrating-type photo-detecting stage further includes a transfer transistor configured to selectively couple the photosensor to the floating diffusion.

26. The EVS pixel of claim 23, wherein the first node includes a first capacitor and a first switch configured to selectively couple the first capacitor to an output of the integrating-type photo-detecting stage.

27. The EVS pixel of claim 26, wherein the second node includes a second capacitor and a second switch configured to selectively couple the second capacitor to the output of the integrating-type photo-detecting stage.

28. The EVS pixel of claim 27, further comprising a source follower transistor having a gate selectively coupled to the first capacitor and the second capacitor via the first switch and the second switch, respectively.

29. The EVS pixel of claim 28, further comprising an analog-to-digital converter (ADC) coupled to an output of the source follower transistor and configured to convert analog signals from the source follower transistor into corresponding digital signals.

30. The EVS pixel of claim 23, wherein:
during first mode of operation, the EVS pixel is configured to—
sample an integrated reference irradiance level using the first node, and
sample a first reset level using the second node, the first reset level corresponding to the integrated reference irradiance level; and
during a second mode of operation, the EVS pixel is configured to—
sample a momentary integrated signal irradiance level using one of the first node or the second node, and
sample a second reset level using another of the first node or the second node, the second reset level corresponding to the momentary integrated signal irradiance level.

31. The EVS pixel of claim 30, further comprising reset circuitry configured to cause the EVS pixel to sample a new integrated reference irradiance level based at least in part on a temporal contrast difference exceeding a contrast threshold, the temporal contrast difference being a digital representation of a difference between a digital representation of the momentary integrated signal irradiance level and a digital representation of the integrated reference irradiance level.

32. The EVS pixel of claim 23, wherein the photosensor includes a pinned photodiode.
